(19) United States
(12) Patent Application Publication
(10) Pub. No.: US 2006/0274024 A1
(43) Pub. Date: Dec. 7, 2006

(54) Liquid crystal display and light emitting diode drive circuit thereof

(75) Inventors: Chin-Der Wey, Miaoli (TW); Chia-Hung Sun, Kaohsiung (TW); Ya-Yun Yu, Taipei (TW); Yi-Chun Yeh, Taipei (TW)

Correspondence Address: BIRCH STEWART KOLASCH & BIRCH, PO BOX 747, FALLS CHURCH, VA, 22040-0747, US

(73) Assignee: AU Optronics Corp.

(21) Appl. No.: 11/267,398

(22) Filed: Nov. 7, 2005

(30) Foreign Application Priority Data
Jun. 2, 2005 (TW) 94118259

(51) Int. Cl. G09G 3/36

(52) U.S. Cl. 345/102

(57) ABSTRACT

A liquid crystal display (LCD) including a light emitting diode (LED) driving circuit and an LED module is provided. The LED module includes a plurality of LEDs. The LED driving circuit includes a transformer, a rectification circuit and a filter circuit. The transformer is used for outputting an AC voltage. The alternate current voltage is respectively rectified and filtered by the rectification circuit and the filter circuit, and then a direct current (DC) voltage level necessary for driving the LEDs is outputted accordingly.

This application claims the benefit of Taiwan application Serial No. 94118259, filed Jun. 2, 2005, the subject matter of which is incorporated herein by reference.

### BACKGROUND OF THE INVENTION

1. Field of the Invention

The invention relates in general to a liquid crystal display (LCD), and more particularly to a light emitting diode (LED) driving circuit.

2. Description of the Related Art

As the size of liquid crystal display (LCD) becomes larger and larger, the backlight module of LCD such as a large-sized LCD TV for instance has to provide a higher standard of luminance so as to maintain image quality. In terms of light emitting diode (LED) backlight module, more LEDs need to be employed in order to provide the luminance capable of maintaining image quality at desired level.

However, in the conventional LED driving circuits including DC-DC converters, power switches and related electronic components for instance, the number of LEDs is limited due to the withstanding voltage and withstanding current of inductance and LED, or due to the step-up and step-down limits of DC-DC converters. Therefore, the object of driving more LEDs can be achieved by employing more DC-DC converters each driving a certain number of LEDs or connecting a number of LEDs in parallel. However, the above method is associated with the problem of having imbalanced current and higher cost. Thus, how to resolve the problem of LED quantity restraint and imbalanced current caused by the output voltage of DC-DC converter and reduce the manufacturing cost of LED driving circuit has become an imminent challenge.

### SUMMARY OF THE INVENTION

It is therefore the object of the invention to provide a liquid crystal display (LCD) and a light emitting diode (LED) driving circuit thereof capable of resolving the problem of having insufficient output voltage and imbalanced current when driving a number of LEDs occurring to conventional DC-DC converter.

According to an object of the invention, an LCD including a number of LEDs and LED driving circuits is provided. The LEDs at least includes a string of serially-connected LEDs. The driving circuit used for driving the LEDs includes a transformer and a rectification circuit. The transformer is used for outputting an alternate current (AC) voltage. The rectification circuit is used for receiving the alternate current voltage and outputting a first direct current (DC) voltage accordingly for driving the LEDs.

According to another object of the invention, an LCD including a backlight module and an LED driving circuit is provided. The backlight module includes a number of first and second LEDs. The first LEDs and the second LEDs are used for providing the LCD with a light source necessary for displaying an image. The driving circuit, which is used for driving the first LEDs and the second LEDs to illuminate, includes a transformer, a first rectification circuit and a second rectification circuit. The transformer includes a first secondary coil and a second secondary coil. The first secondary coil is used for outputting a first AC voltage. The second secondary coil is used for outputting a second AC voltage. The first rectification circuit is used for receiving the first alternate current voltage and outputting a first direct current voltage accordingly for driving the first LEDs. The second rectification circuit is used for receiving the second alternate current voltage and outputting a second direct current voltage accordingly for driving the second LEDs.

According to yet another object of the invention, an LED driving circuit used for driving a number of LEDs is provided. The driving circuit includes a transformer and a rectification circuit. The transformer is used for outputting an AC voltage. The rectification circuit is used for receiving the alternate current voltage and outputting a first direct current voltage accordingly for driving the LEDs. The LED is used for providing the LCD with a light source necessary for displaying an image.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram of an LCD according to a first embodiment of the invention;

FIG. 2 is another diagram of the LCD; and

FIG. 3 a diagram of an LCD according to a second embodiment of the invention.

### DETAILED DESCRIPTION OF THE INVENTION

The invention provides a liquid crystal display (LCD) and a light emitting diode (LED) driving circuit thereof capable of resolving the problem of having insufficient output voltage and imbalanced current when driving a number of LEDs by a conventional DC-DC converter under a large-scaled LCD.

### First Embodiment

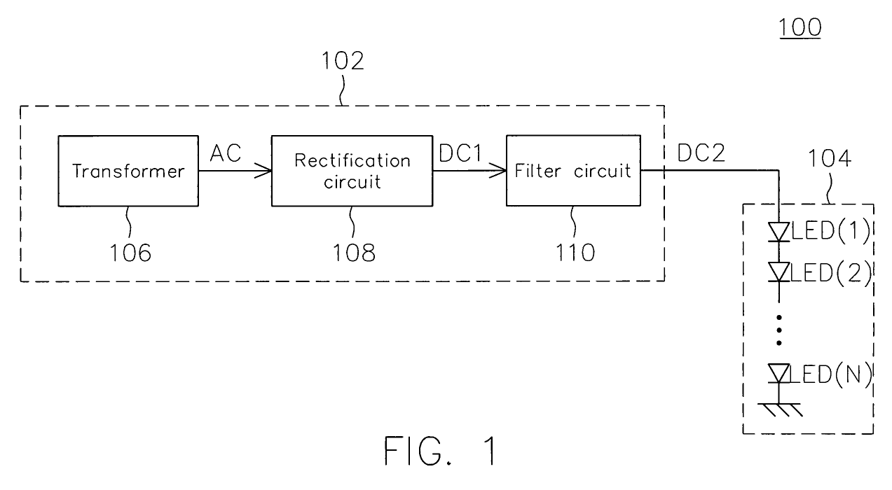

Referring to FIG. 1, a diagram of an LCD according to a first embodiment of the invention is shown. LCD 100 includes an LED driving circuit 102 and an LED module 104. The LED module 104 can have N light emitting diodes, namely, LED(1)-LED(N), where N is a positive integer. The LED driving circuit 102 includes a transformer 106, a rectification circuit 108 and a filter circuit 110. The N light emitting diodes, capable of generating white light, are applied in a backlight module and electrically connected to each other in serial or in parallel. FIG. 1 illustrates a serial connection. However, the present embodiment neither limits the LEDs to be electrically connected in serial or in parallel, nor limit the luminance color or number of LEDs. For example, when N=60, the 60 light emitting diodes LED(1)˜LED(60) can be divided into two serials. That is, the first 30 light emitting diodes LED(1)˜LED(30) and the remaining 30 light emitting diodes LED(31)˜LED(60) are respectively connected in serial first, and then the two serially-connected strings of light emitting diodes are connected in parallel.

The above backlight module is used for providing the LCD 100 with a light source for displaying an image (the backlight module is not shown in FIG. 1). The transformer 106 is used for outputting an alternate current voltage AC. The alternate current voltage AC is rectified and filtered by the rectification circuit 108 and the filter circuit 110 respectively, and then a direct current voltage level required for driving the N light emitting diodes is outputted accordingly.

In other words, the alternate current voltage AC is converted into a first direct current voltage DC1 by the rectification circuit 108. The rectification circuit 108 can be full/half-bridge rectification circuit or other circuits. According to the present embodiment, the rectification circuit 108 is not limited to a specific type; any circuit capable of converting the alternate current voltage AC into a direct current voltage (a first direct current voltage DC1 for instance) will do. The first direct current voltage DC1, after being filtered by the filter circuit 110, is converted into a second direct current voltage DC2 whose voltage change is smoother. The second direct current voltage DC2 drives the N light emitting diodes to illuminate. The filter circuit 110 can include a serially-connected inductances L and a parallel-connected capacitance C for instance. The inductance L and the capacitance C are not shown in FIG. 1.

Due to the characteristics or the restrictions of electronic components in the DC-DC converter, the direct current voltage level outputted by a conventional DC-DC converter such as a boost converter has a limit and can not be too high. Therefore, in order to drive more LEDs, the LEDs have to be connected in parallel according to conventional method. However, the LEDs are disadvantaged by having a non-uniformed distribution of luminance under parallel connection. Alternatively, in order to drive more LEDs when the LCD becomes larger, more boost converters each driving a certain number of LEDs are used. However, the luminance of LEDs driven by different boost converters is different.

Compared with the conventional method disclosed above, the design of the invention provides an alternate current voltage AC with a higher voltage level in correspondence to the direct current voltage level required fro driving the LEDs. That is, with the step-up and step-down characteristics of the transformer 106 and the combination between the rectification circuit 108 and the filter circuit 110, the invention is not subject to the step-up limit of the boost converter. When more and more LEDs are required as the size of the LCD becomes larger and larger, the direct current voltage level required for driving the LEDs can be generated according to the step-up and step-down characteristics of the transformer 106 and the combination between the rectification circuit 108 and the filter circuit 110. The required direct current voltage level is the second direct current voltage DC2. In other words, the LEDs are not subject to the limit imposed on the output voltage level of the boost converter, and more LEDs can be serially connected to achieve the desired luminance intensity. Furthermore, the LEDs have an even uniformed distribution of luminance when connected in serial.

The present embodiment resolves the problem of having insufficient output voltage and imbalanced current when driving a number of LEDs. Moreover, the LED driving circuit 102 drives more LEDs than the DC-DC converters would do. Therefore, the LED driving circuit 102 of the embodiment uses less DC-DC converters and control ICs, thus reducing the manufacturing cost further.

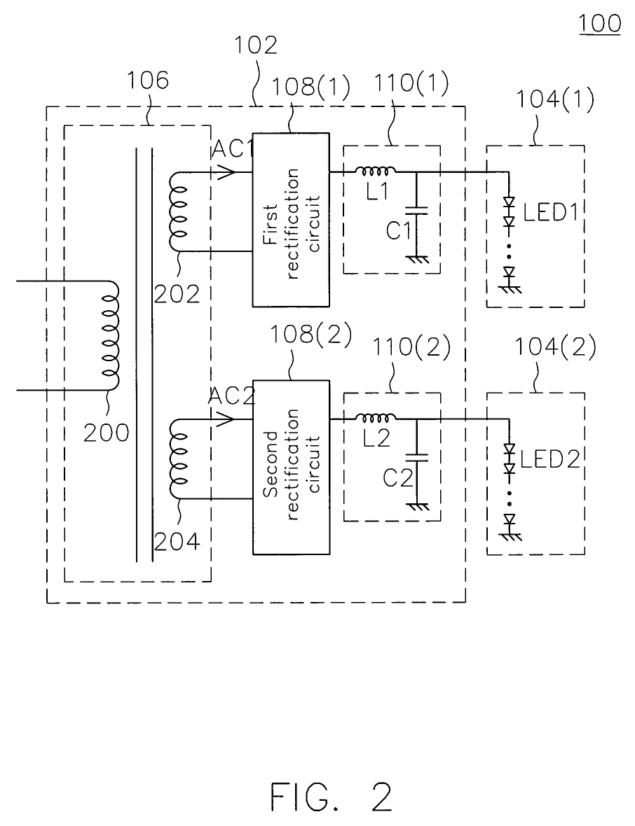

The alternate current voltage received by the transformer 106 can be obtained by converting a direct current voltage provided by the LCD 100 or an electric supply such as AC 110 directly. The present embodiment is not subject to the source of the alternate current voltage received by the transformer 106; any power source capable of generating the alternate current voltage AC required for driving the LEDs will do. Within the capacity of the transformer 106, the transformer 106 can have a number of secondary coils. Each output signals of the secondary coils is rectified and filtered by their respective rectification circuit and filter circuit, and then drives their corresponding LED modules respectively. Referring to FIG. 2, another diagram of the LCD is shown. The LCD 100 can include two LED modules, namely, a first LED module 104(1) and a second LED module 104(2). The first LED module 104(1) and the second LED module 104(2) respectively have a number of serially connected LEDs. The secondary coil of the transformer 106 includes a first secondary coil 202 and a second secondary coil 204. The primary coil 200 of the transformer 106 receives AC110 V for instance. As for the secondary coil, the first secondary coil 202 is adapted to provide a first alternate current voltage AC1, and the second secondary coil 204 is adapted to provide a second alternate current voltage AC2. After having been rectified and filtered by the first rectification circuit 108(1) and the first filter circuit 110(1) respectively, the first alternate current voltage AC1 drives the first LED module 104(1) accordingly. The first filter circuit 110(1) can be formed by a first inductance L1 and a first capacitance C1, and the second filter circuit 110(2) can be formed by a second inductance L2 and a second capacitance C2. Similarly, the method of driving the second LED module 104(2) is not repeated here. It is noteworthy that when the second LED module 104(2) has the same number of LEDs with that of the first LED module 104(1), the drive current of the second LED module 104(2) and the drive current of the first LED module 104(1) would be balanced. That is, the LED modules 104(1) and 104(2) would have an even uniformed distribution of luminance, if the first secondary coil 202 and the second secondary coil 204 substantially have the same number of turns and these turns are evenly coiled around the same iron core.

### Second Embodiment

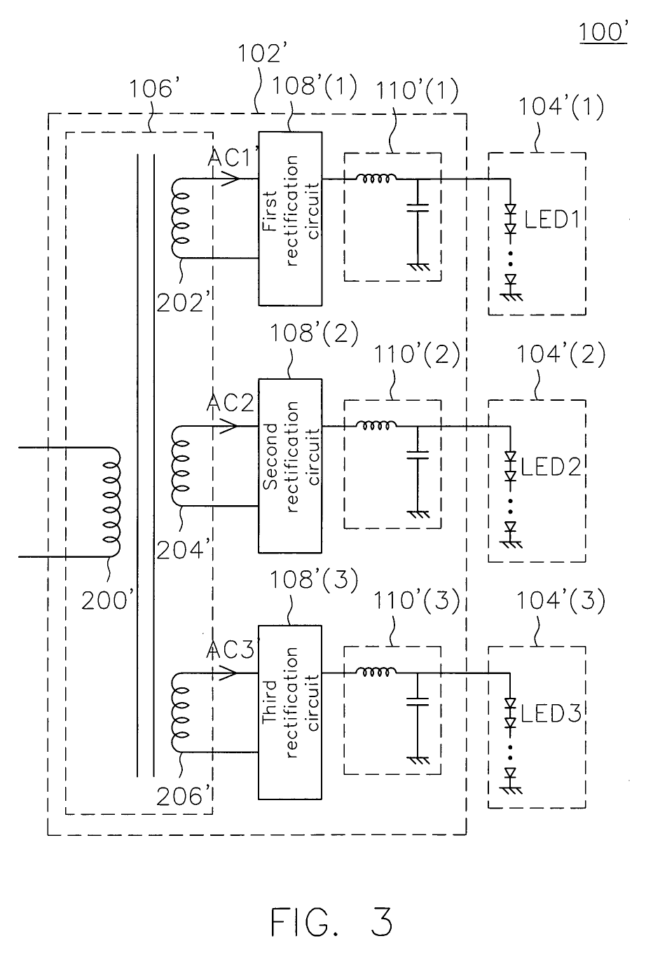

Besides, the white light of the backlight module can be generated by mixing the light of the red/green/blue (RGB) LEDs. The transformer can further provide the alternate current voltages required for driving the RGB LED modules. Referring to FIG. 3, a diagram of an LCD according to a second embodiment of the invention is shown. Similarly, the LCD 100′ also includes an LED driving circuit 102′ and three LED modules 104′. The three LED modules 104′ respectively are a first LED module 104′(1), a second LED module 104′(2) and a third LED module 104′(3). The first LED module 104′(1) has a number of first light emitting diodes LED1 such as the red LEDs for instance. The second LED module 104′(2) has a number of second light emitting diodes LED2 such as the green LEDs for instance. The third LED module 104′(3) has a number of third light emitting diodes LED3 such as the blue LEDs for instance. The first light emitting diodes LED1, the second light emitting diodes LED2 and the third light emitting diodes LED3 can have the same or different numbers of light emitting diodes according to the needs of the luminance intensity or the design.

The LED driving circuit 102′ further includes three rectification circuits 108′ and three filter circuit 110′. The three rectification circuits 108′ include a first rectification circuit 108′(1), a second rectification circuit 108′(2) and a third rectification circuit 108′(3). The three filter circuits 110′ include a first filter circuit 110′(1), a second filter circuit 110′(2) and a third filter circuit 110′(3). The secondary coil of the transformer 106′ includes a first secondary coil 202′, a second secondary coil 204′ and a third secondary coil 206′. The primary coil 200′ of the transformer 106′ receives an AC110 V for instance. The first secondary coil 202′, the second secondary coil 204′ and the third secondary coil 206′ are respectively used for outputting a first alternate current voltage AC1′, a second alternate current voltage AC2′, and a third alternate current voltage AC3′.

Likewise, the corresponding alternate current voltages AC1′˜AC3′ are respectively rectified and filtered by the rectification circuit 108′ and the filter circuit 110′, and then the direct current voltage level required for driving the corresponding LED module 104′ is outputted accordingly. That is, the secondary coils 202′, 204′ and 206′ respectively correspond to their respective direct current voltage levels required for driving the LED modules 104′(1)˜104′(3) and respectively generate corresponding alternate current voltages AC1′˜AC3′. For example, in correspondence to the number of the first light emitting diode LED1, the first secondary coil 202′ generates a first alternate current voltage AC1′ required for driving the first light emitting diode LED1.

Like the first embodiment, with the step-up and step-down characteristics of the transformer 106′ and the combination between the rectification circuit 108′ and the filter circuit 110′, the present embodiment is not subject to the step-up limit of the boost converter, thus generating a direct current voltage level required for driving the LEDs which can be connected in serial. The luminance of each of the LED modules 104′(1)˜104′(3) is more uniformed when the LED modules are connected in serial.

In practical application, the LCD or the LED driving circuit according to the invention can be used to drive a few LEDs, a few dozens of LEDs or a few hundreds of LEDs according to the needs of the design or the luminance of the LED. The LEDs can be connected in serial or the LEDs includes of a number of strings of serially-connected LEDs which are connected in parallel.

Compared with the design using a DC-DC converter, the LED driving circuit 102′ of the present embodiment reduces the required number of control ICs and related electronic components used in the DC-DC converter, thus reducing the manufacturing cost of the LED driving circuit 102′.

The liquid crystal display and the light emitting diode driving circuit thereof disclosed in above embodiments of the invention not only resolves the problem of having a DC-DC converter whose insufficient output voltage is insufficient when driving a large-sized LCD but further reduces the manufacturing cost of LED driving circuit.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display (LCD), comprising:
a plurality of light emitting diodes (LEDs) include at least a string of serially-connected LEDs; and
a driving circuit for driving the LEDs, wherein the driving circuit comprises:
a transformer for providing an AC voltage; and
a rectification circuit for receiving the AC voltage and for providing a first DC voltage in accordance with the AC voltage to drive the LEDs.

2. The LCD according to claim 1, wherein the driving circuit further comprises:
a filter circuit for receiving the first DC voltage and for providing a second DC voltage in accordance with the first DC to drive the LEDs.

3. The LCD according to claim 1, wherein the LEDs includes of a number of strings of serially-connected LEDs which are connected in parallel.

4. An LCD, comprising:
a backlight module, comprising:
a plurality of first LEDs and a plurality of second LEDs, wherein the first LEDs and the second LEDs is configured to provide the LCD with a light source for displaying an image; and
a driving circuit for driving the first LEDs and the second LEDs, wherein the driving circuit comprises:
a transformer having a first secondary coil and a second secondary coil, wherein the first secondary coil is adapted to provide a first AC voltage, and the second secondary coil is adapted to provide a second AC voltage;
a first rectification circuit for receiving the first AC voltage and for providing a first DC voltage in accordance with the first AC voltage to drive the first LEDs; and
a second rectification circuit for receiving the second AC voltage and for providing a second DC voltage in accordance with the second AC voltage to drive the second LEDs.

5. The LCD according to claim 4, wherein the driving circuit further comprises:
a first filter circuit for receiving the first DC voltage and for providing a third DC voltage in accordance with the first DC voltage to drive the first LEDs; and
a second filter circuit for receiving the second DC voltage and for providing a fourth DC voltage in accordance with the second DC voltage to drive the second LEDs.

6. The LCD according to claim 4, wherein the backlight module further comprises a plurality of third LEDs adapting to provide the LCD with a light source for displaying an image.

7. The LCD according to claim 6, wherein the transformer further comprises a third secondary coil adapting to provide a third AC voltage, the driving circuit further comprises:
a third rectification circuit for receiving the third AC voltage and for providing a fifth DC voltage in accordance with the third AC voltage; and
a third filter circuit for receiving the fifth AC voltage and for providing a sixth DC voltage in accordance with the fifth AC voltage to drive the third LEDs.

8. The LCD according to claim 7, wherein the first rectification circuit, the second rectification circuit, and the third rectification circuit are full-bridge rectification circuits.

9. The LCD according to claim 7, wherein the first rectification circuit, the second rectification circuit, and the third rectification circuit are a half-bridge rectification circuits.

10. The LCD according to claim 7, wherein the first LEDs are of the same color, the second LEDs are of the same color, and the third LEDs are of the same color, and the first LEDs, the second LEDs, and the third LEDs are of different colors.

11. The LCD according to claim 7, wherein the first LEDs, the second LEDs, and the third LEDs have different number of LEDs.

12. A driving circuit for driving a plurality of LEDs, comprising:
a transformer for providing an AC voltage; and
a rectification circuit for providing a first DC voltage in response to the AC voltage to drive the LEDs, wherein the LEDs are adapted to provide the LCD with a light source for displaying an image.

13. The driving circuit according to claim 12, wherein the driving circuit further comprises:
a filter circuit for receiving the first DC voltage and for providing a second DC voltage in accordance with the first DC voltage to drive the LEDs.

14. The driving circuit according to claim 12, wherein the rectification circuit is a full-bridge rectification circuit.

15. The driving circuit according to claim 12, wherein the rectification circuit is a half-bridge rectification circuit.
